(19) United States
(12) Patent Application Publication
(10) Pub. No.: US 2008/0021846 A1
(43) Pub. Date: Jan. 24, 2008

(54) Global education support fund

(76) Inventor: Eric-Vincent Guichard, Washington, DC (US)

Correspondence Address: MCKENNA LONG & ALDRIDGE LLP, 1900 K STREET, NW, WASHINGTON, DC, 20006, US

(21) Appl. No.: 11/878,311

(22) Filed: Jul. 23, 2007

Related U.S. Application Data
(60) Provisional application No. 60/832,222, filed on Jul. 21, 2006.

(51) Int. Cl. G06Q 40/00

(52) U.S. Cl. 705/36 R

(57) ABSTRACT

The Global Education Savings Fund (GESF) addresses the need for reliable and comprehensive funding for educational expenses. The GESF provides access to capital on a non-recourse basis, provides targeted capital at terms to fund education, provides a tactical allocation that increases probability of success, and provides capital guarantees that protect household/enterprise set-aside funds.

This application claims the benefit of U.S. Provisional Patent Application No. 60/832,222, filed on Jul. 21, 2006, which is hereby incorporated by reference for all purposes as if fully set forth herein. In addition, this application incorporates by reference U.S. patent application Ser. No. 11/797,218 in its entirety for all purposes as if fully set forth herein.

### BACKGROUND OF THE INVENTION

1. Field of the Invention

The present invention relates to a global education support fund (the GESF), which is an educational funding and investment arrangement targeted at individuals, households, and enterprises with insufficient fund to meet the costs of primary, secondary, or post-secondary education.

2. Discussion of the Related Art

The cost of education, both public and private, are increasing far beyond the rate of inflation. In addition, the market for highly skilled workers is becoming increasingly competitive, making post-secondary education a mandatory requirement for many careers.

Current available solutions for funding education involve deferred tax treatments of household income set asides, but these rely heavily on the performance of the underlying investment vehicles (e.g.: 529, endowments) to successfully meet educational expenses. When there is a shortfall, as often occurs, the difference must be made up out of the students or household's pocket. What is needed is a way to provide households with access to capital on a non-recourse and preferential term basis.

### SUMMARY OF THE INVENTION

Accordingly, the present invention is directed to a global education support fund that substantially obviates one or more of the problems due to limitations and disadvantages of the related art.

An advantage of the present invention is to provide access to capital markets at favorable or minimal costs of capital. Other advantages of the present invention are conversion of the global education support fund to a different asset class, leverage in the form of negotiated loan arrangements with banks, diversification of investments, risk-reducing and return enhancing asset allocations, and principal protection and principal guarantee at term.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings. To achieve these and other advantages and in accordance with the purpose of the present invention, as embodied and broadly described, a method of structuring an investment includes investing a principal amount in a fund, wherein said principal amount includes an initial investment by an investor; managing a portfolio into which said principal amount is invested, said portfolio including a plurality of assets, each of said assets having a credit rating and a rate of return; borrowing an amount equal to a fraction of said principal at a reduced rate of interest, said principal being collateral for said loan; insuring at least a portion of the principal wherein the loan is invested in said portfolio in addition to said principal, and wherein at least a portion of the returns from said portfolio are reinvested.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates a dynamic portfolio allocation in accordance with the present invention.

### DETAILED DESCRIPTION OF THE ILLUSTRATED EMBODIMENTS

Reference will now be made in detail to an embodiment of the present invention, example of which is illustrated in the accompanying drawings.

The Global Education Savings Fund (GESF) is both a household/retail and institutional education funding mechanism that takes into account the scarcity of available capital earmarked for funding primary, secondary and tertiary education, and is able to provide households with access to capital on a non-recourse and preferential term basis.

In particular, the Global Education Savings Fund (GESF) accomplishes the following: provides access to capital on a non-recourse basis, provides targeted capital at terms to fund education, provides a tactical allocation that increases probability of success, and provides capital guarantees that protect household/enterprise set-aside funds.

To achieve these aims, the GESF has key relationships with financial institutions to provide capital at preferential rates, insurance to provide capital guarantees, fund advisors for judicious tactical allocation strategies, administrators to facilitate interface with clients, and auditors to provide transparency and reporting. The details of the financial arrangements including the relationships between the investors, financial institutions, and insurers may be similar to those describe in co-pending application 11/797,218, which is hereby incorporated by reference for all purposes as if fully set forth herein.

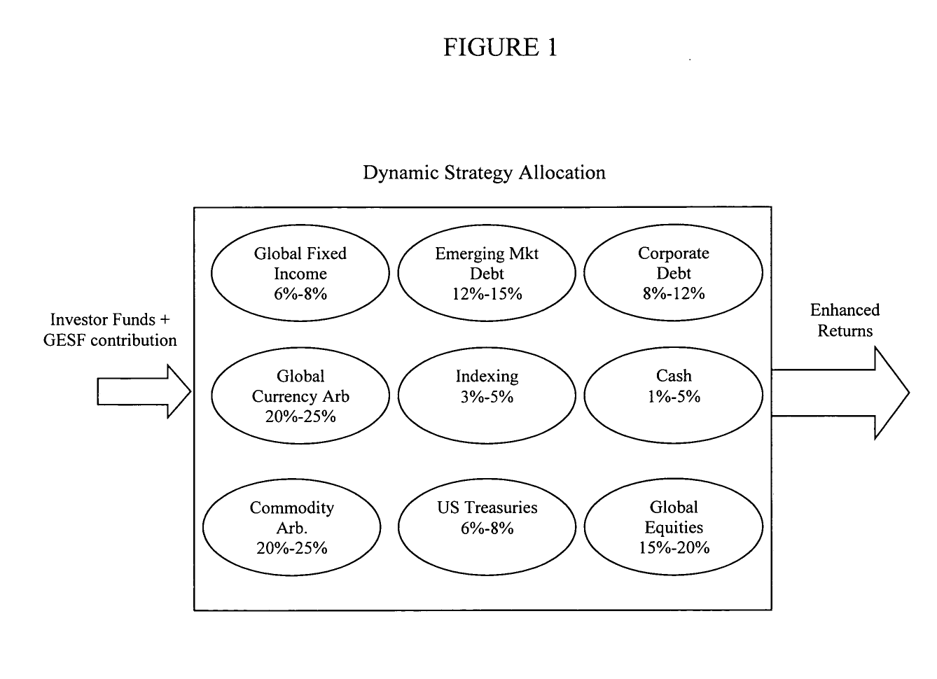

Based on these relationships, the GESF is able to borrow capital at preferred (lower) interest rates from financial institution partners, because the GESF purchases insurance to guarantee the principal. The insurer is willing to provide the GESF his capital insurance because the GESF's fund advisors manage a diversified portfolio of assets, currencies, and investment vehicles. For example, FIG. 1 illustrates a dynamic portfolio allocation in including a wide variety of investments having diverse risk-return profiles. These investments may include emerging market debt, currency arbitrage, equities or equity funds, private equity investments, real estate trusts, hedge fund investments or the like. The fund is not limited to public investment vehicles, but is able to commit resources to closed, private investment vehicles such as private equity or hedge funds because the financial institution partners will lend the fund the capital necessary for private equity or hedge fund commitments.

In effect, GESF will contribute additional dollars for every dollar a household sets aside for future education costs. In addition GESF will provide guarantees on set asides made by households

The process involves GESF structuring lending relationships that enable it to make funds available at its discretion to investors in order to facilitate attainment of target amounts for funding education at some future predetermined date.

GESF is structured in such a way as to take advantage of various deferred tax strategies available to various investors. Each investor is a shareholder of the fund and can withdraw at any point in time contingent on early withdrawal penalties.

GESF focuses on tactical and strategic asset allocation within a controlled framework that increases the probability to achieve its target returns. This is done in conjunction with various creditor partners of the program.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of structuring an investment, comprising:
investing a principal amount in a fund, wherein said principal amount includes an initial investment by an investor;
managing a portfolio into which said principal amount is invested, said portfolio including a plurality of assets, each of said assets having a credit rating and a rate of return;
borrowing an amount equal to a fraction of said principal at a reduced rate of interest, said principal being collateral for said loan;
insuring at least a portion of the principal
wherein the loan is invested in said portfolio in addition to said principal, and wherein at least a portion of the returns from said portfolio are reinvested.
